(19) United States
(12) Patent Application Publication
(10) Pub. No.: US 2014/0258083 A1
(43) Pub. Date: Sep. 11, 2014

(54) SYSTEMS AND METHODS FOR MICROFINANCE CREDIT DATA PROCESSING AND REPORTING

(71) Applicants: Venkat Achanta, Richmond, VA (US); Karthikeyan Reddy Aaravabhoomi, Irvine, CA (US); Patricia Cheryl Lassen, Orange, CA (US)

(72) Inventors: Venkat Achanta, Richmond, VA (US); Karthikeyan Reddy Aaravabhoomi, Irvine, CA (US); Patricia Cheryl Lassen, Orange, CA (US)

(21) Appl. No.: 13/787,548

(22) Filed: Mar. 6, 2013

(51) Int. Cl. G06Q 40/02

(52) U.S. Cl. CPC G06Q 40/025
USPC 705/38

(57) ABSTRACT

Systems and methods are provided for processing microfinance-related credit data and generating credit reports based on the processed microfinance credit data. Payment status may be determined for each entry in a payment grid, which may correspond to a payment interval such as, for example, daily, weekly or monthly. Credit reports may be generated with selectable options enabling the user to view at least one other payment grid having entries corresponding to a different payment interval.

### LIMITED COPYRIGHT AUTHORIZATION

A portion of disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### BACKGROUND OF THE DISCLOSURE

1. Field of the Disclosure

Among other things, this disclosure describes systems and methods for processing microfinance credit data and other data received from a number of data sources, and providing credit-related products and other products based on the processed data.

2. Description of the Related Art

Microfinance is a provision of financial services such as loans, insurance, and so forth offered by different types of service providers for low-income clients. Microfinance borrowers are bounded to make small payments to the creditor in a payment cycle which may call for payments at daily or weekly intervals, instead of a more traditional monthly payment cycle.

Credit data may be maintained by a credit bureau or similar entity. Credit data maintained by a given credit bureau may include account data for millions or even billions of customers, where each customer identified in the data may have one or more accounts. The credit data may be based on several sources of data, which include existing trade data, new trade data, inquiries, public record data (for example, bankruptcy filings), change of address data, and so forth. A common type of credit data is “tradeline data” (or trade data). Tradeline data may be an entry by a credit grantor to a consumer's credit history which is maintained by a credit reporting agency. A tradeline describes the consumer's account status and activity and can include names of companies with which the applicant has accounts, dates the accounts were opened, credit limits, types of accounts, account balances, payment histories, and/or other data.

In the United States, for example, multiple credit bureaus are constantly receiving data from a large number of data sources, including, for example, banks, creditors, and other account providers. The credit bureaus use the data, among other things, to provide credit reports, credit scores, and other credit-related products or services to consumers and businesses. The systems of a given credit bureau are typically tailored to specific legal and business requirements of the country or region in which the bureau operates, as well as the needs of its customers, which may have evolved over a long period of time. Currently, the systems of a typical credit bureau are not easily adaptable to comply with the needs of reporting microfinance credit data.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 illustrates one embodiment of a data flow in an illustrative operating environment for maintaining credit data received from a variety of data sources and providing microfinance credit-related products to consumers and subscribers.

FIG. 2 is a flowchart that illustrates the process of receiving, processing, sorting, validating, and loading microfinance credit data.

FIG. 3 is a flowchart that illustrates the process of generating a user interface for microfinance data.

FIG. 4 illustrates one embodiment of a system for processing credit data.

FIG. 5 is an illustrative embodiment of a user interface that may be generated and presented to a user. The user interface shows one embodiment of a monthly view of a credit report.

FIG. 6 is an illustrative embodiment of a user interface that may be generated and presented to a user. The user interface shows one embodiment of a daily view of a credit report.

FIG. 7 is an illustrative embodiment of a user interface that may be generated and presented to a user. The user interface shows one embodiment of a weekly view of a credit report.

FIG. 8 is an illustrative embodiment of a user interface for the user to customize the payment grid used for credit reporting.

FIG. 9 is an illustrative embodiment of a user interface for the user to set a default payment grid for a particular account.

### DETAILED DESCRIPTION

Various embodiments of systems, methods, processes, and data structures will now be described with reference to the drawings. Variations to the systems, methods, processes, and data structures, which represent other embodiments, will also be described. Certain aspects, advantages, and novel features of the systems, methods, processes, and data structures are described herein. It is to be understood that not necessarily all such advantages may be achieved in accordance with any particular embodiment. Accordingly, the systems, methods, processes, and/or data structures may be embodied or carried out in a manner that achieves one advantage or group of advantages as taught herein without necessarily achieving other advantages as may be taught or suggested herein.

Generally described, aspects of the present disclosure relate to systems and methods that enable a credit bureau or other entity that maintains credit data to receive, process, and report microfinance credit data. Traditional credit reporting systems are not well adjusted to collect, process, or report microfinance credit data because microfinance credit data may be reported using payment periods that differ from usual payment periods used in traditional credit reporting. Moreover, credit bureaus and other entities may need to adjust payment intervals for a credit account based on varying reporting needs. According to aspects of the present disclosure, a single microfinance credit account may be displayed using several different payment intervals for various credit processing and reporting purposes. According to some embodiments, a credit bureau or other entity may use more than one method to determine delinquency of a microfinance credit account based on payment intervals, reporting periods, client needs, and/or other criteria.

As discussed herein, aspects of the present disclosure include a credit reporting system. The credit reporting system may include a database configured to store a plurality of records, where the plurality of records may include credit data associated with each of a plurality of accounts. The database may be configured to store credit data that includes payment status information for accounts associated with a plurality of payment intervals. The credit reporting system may also include a credit report generation system, which may be configured to electronically communicate with the database. The credit reporting system may include a report module. The report module may be configured to receive a report request indication identifying a first individual for whom a credit report should be generated. The report module may be further configured to retrieve credit data associated with the individual from the database, where the retrieved credit data may include payment status information associated with a first financial account of the individual. The report module may determine payment status for each entry in a first payment grid representing the retrieved credit data. The first payment grid may have entries corresponding to a first payment interval. The first payment interval may include one of daily, weekly, and monthly. The report module may determine payment status for each entry in a second payment grid representing the retrieved credit data. The second payment grid may have entries corresponding to a second payment interval, which is different than the first payment interval. The second payment interval may include one of daily, weekly, and monthly. The credit report generation system may also include a user interface module, which may be configured to present a credit report including the first payment grid, which may have entries corresponding to the first payment interval. The credit report may include at least one selectable option enabling the user to view the second payment grid, which has entries corresponding to the second payment interval. In response to a user selection of the at least one selectable option, the user interface module may present the second payment grid having entries corresponding to the second payment interval.

### Example Credit Reporting Environment and Data Flow

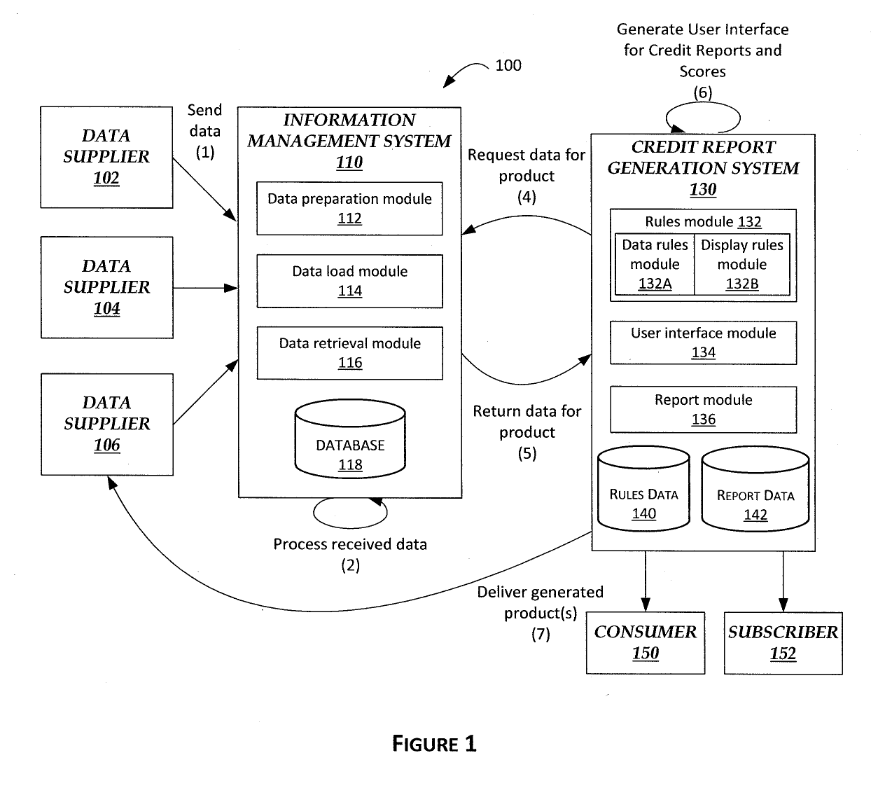

FIG. 1 illustrates one embodiment of an architecture and overall data flow of an illustrative operating environment 100 for maintaining microfinance credit data and other data received from a variety of data sources and providing credit-related products to consumers and subscribers, such as credit bureau operators, operators and decision-makers in banks, or other financial institutions that make credit and/or loan-related decisions.

Data suppliers 102, 104, and 106 may include traditional lending institutions such as banks, credit unions, large businesses, and/or mortgage companies. Because of the unique nature of microfinance credit data, the data suppliers may also include non-traditional lenders, such as individuals, payday loan providers or small businesses.

As illustrated, the illustrative operating environment 100 includes an information management system 110 and a credit report generation system 130. The information management system 110 receives microfinance credit data from various data suppliers. The credit report generation system 130 communicates with the information management system 110 to process and report microfinance credit data. The credit report generation system 130 may also provide credit reports and/or other output to subscribers such as credit bureaus, lenders, various account or service providers, and/or data suppliers.

In certain embodiments, the information management system 110 and a credit report generation system 130 may be collectively operated by a credit bureau or similar entity in order to receive, process, maintain and/or analyze credit data and other types of data relevant to consumers and businesses, including generating products, such as credit reports and credit scores, based on the processed data. The components illustrated in FIG. 1 may each be configurable based on particular needs of a specific operator. In some embodiments, each system and/or module illustrated in illustrative operating environment 100 may be responsible for implementing certain features, such that a given component, system and/or module may be swapped with a replaced or modified component, system or module without affecting performance of the operating environment as a whole or requiring changes to the other components, systems or modules. In some embodiments, a credit bureau or a similar entity may receive, load, process and/or store data in a manner similar to that described in U.S. patent application Ser. No. 13/546,965, entitled “Systems and Methods for Large-Scale Credit Data Processing,” which is hereby incorporated by reference in its entirety herein. The various components of illustrative operating environment 100 are described in more detail below, followed by a description of the overall data flow illustrated in FIG. 1.

### Information Management System

The information management system 110 may, in some embodiments, be configured to load and process high volumes of credit data, including microfinance credit data, received from a variety of data suppliers or data sources, including sources for microfinance credit data. In some embodiments, the credit data from multiple sources may be processed in parallel and loaded to the database 118 without affecting the performance of the credit report generation system 130. The information management system 110 may enable horizontal scaling in which various data entries may be matched to a personal identifier, business identifier or other entity identifier in real-time or near real-time prior to, or in parallel with, other data processing tasks.

Data consistency may be maintained, for example, by combining transaction objects such as trade, public records and entity objects (such as name, address and/or other data entries) into a single data object with flexible formatting requirements. In some embodiments, the data object may be stored in a dynamic, variable-length object structure. Accordingly, the information management system 110 may combine and/or bind data together, and may process the data in a transaction mode based on the created data objects. For example, each record or data entry may be processed as a discrete transaction, where transactions may each be processed independently in parallel with other transactions, or may be processed in batches with other records, depending on the embodiment. In some embodiments, the information management system may provide an adaptable framework that can easily be modified or expanded to accept and process data of different types, especially microfinance data, which may not be reported monthly. For example, rules and/or definitions may be identified or defined relative to specific data types, data fields, data sources, and/or other data elements or associations.

As illustrated, the information management system 110 includes a data preparation module 112, a data load module 114, a data retrieval module 116, and a database 118. The data preparation module 112 may prepare received data to be loaded into the database 118. For example, the data preparation module 112 may reformat data, de-duplicate data, parse data, validate input, and/or split the data. In other embodiments, the data preparation module 112 may prepare and receive data to be loaded into a master data systems or other processing system that generally maintains processed data in a form that is accessible for generation of credit reports, credit score and/or other products that utilize the stored data. In other embodiments, the information management system 110 handles such maintenance and processing of data.

In some embodiments, microfinance credit data may be reported from a data supplier to the information management system 110 using a format that is not one of the conventional credit data formats. According to some aspects of this invention, data preparation module 112 may perform data preparation functions to convert microfinance credit data received from data suppliers 102, 104, and 106 into an existing credit reporting file format or a new file format. In some embodiments, the data preparation module 112 may receive an input microfinance credit data file from a data supplier 102, and detect the type of document received and the type of documents usually received from a data supplier. For example, if a microfinance credit data supplier 102 usually sends microfinance credit data in a specific spreadsheet file format, the data preparation module 112 may retrieve a file conversion function, rule set or specification configured to convert the received spreadsheet file into a standard format for further processing and loading. In another example, if the data preparation module 112 receives a new microfinance credit data file from data supplier 106 for the first time, and the file is in an XML format, the data preparation module 112 may use a different parsing and analysis function to prepare the received file for further processing.

In another example, the data preparation module 112 may receive a microfinance data file and analyze the file to determine how to convert the file into one of the existing credit data reporting formats, such as the Consumer Credit Account (CCA) or Business Credit Account (BCA) universal credit reporting formats or a proprietary data format designed to accommodate non-traditional credit data. In some cases, the received data may not be in any previously known file format, and processing such microfinance credit data may require machine-learning or artificial intelligence-based data recognition processing tools. Moreover, if the data preparation module 112 determines that there are new fields that need to be defined in order to capture the information related to microfinance credit reporting, then the data preparation may create new data fields. In some embodiments, the data preparation module 112 may be configured to handle various input file formats and accommodate the unique features of microfinance credit data, such that the specific formatting and data fields stored for a given set of input data may depend on the types of data received in a given instance.

The data load module 114 may extract data, load data, perform delta operations, match data, cleanse data, and/or perform load validation when storing data to the database 118. Reformatting the data may include converting data received and prepared by the data preparation module 112 into data fields capable of being stored and processed by the various components described herein. For example, data may be received in a format specified by one or more country's regulations as a standard credit data format and processed by the data preparation module 112 into a file format readable by the data load module 114. The data load module 114 may further reformat the data into a proprietary format or other universal format for ease of processing, storage, and credit reporting. The data load module 114 may perform matching, which may include identifying each record in the data and matching each record (directly or indirectly) to a uniquely identified individual, business or other entity. For example, if the microfinance credit data is related to an individual, and the individual's social security number, address, and data of birth are provided, the data load module 114 may match these data fields with an existing database of credit data, which may contain past credit reports and other records about this particular individual. In some embodiments, if matching fails, the data load module 114 may search other databases to see if the individual in the received data may be found using an alternative address, and so forth. In some embodiments, if efforts to locate a previously stored record for the individual have all failed, the data load module 114 may return an error and provide feedback to the data supplier for possible correction of the received data. In other embodiments, the data load module 114 may create a data record for a new individual, which may occur, for example, in a case where microfinance credit data is received for an individual that has not previously received traditional loans or other credit.

As will be appreciated, the data preparation module 112 and data load module 114 may be combined in a single module and/or may each perform a different combination of features, depending on the embodiment, based on the various features of the received microfinance credit data and the different needs for reporting.

The information management system 110 may, according to certain embodiments, perform microfinance credit data loading and/or processing as well as data quality control. For example, when each of data suppliers 102, 104 and 106 sends data to the information management system 110 for processing and storage, the information management system 110 may determine whether the data is valid or whether it falls outside of defined quality thresholds established for the specific data supplier. In some embodiments, for example, the information management system 110 may determine that the microfinance credit data received from a certain data supplier 104 is of poor quality. For example, important fields such as identifying information of borrowers may be missing, such that the information management system 110 does not have enough information to confidently associate the data with an account or an individual. In another example, the received data may be too sparse for meaningful reporting. In such cases, the information management system may flag the data as low-quality or require further input from the data supplier 104. In some embodiments, the information management system 110 may still store low-quality microfinance credit data, optionally storing confidence indicators indicating how much the data should be trusted for determining credit scores or for other credit reporting purposes (for example, poor quality data may be weighted lower in certain calculations, or may not be considered at all).

In some embodiments, aspects of the present disclosure may enable processing and reporting of a number of different alternative data types that are not typically stored or reported in association with a credit bureau. Accordingly, in some such embodiments, multiple data formats may be accepted and reformatted into standard formats in order to be loaded and made available for reporting purposes, scoring purposes and/or other use. Some data types that may be loaded, processed, stored and reported, in some embodiments, may include automobile data, asset data, insurance data, marriage data, birth data, deceased data, criminal data, traffic data, renters data, social networking data, license data (such as professional licenses or fish and game licenses), utility data, pet registration data, and/or government traitor data. The received data of various types may be stored separately from credit data, in some embodiments, and may be associated with common or associated entities, such as a person and/or a business that is also associated with credit data. Once these alternative data types are tied to a person, for example, they may be used in generating one or more credit reports, scores and/or other products regarding the person. As one example, a credit report or other product for an individual may be generated that includes information regarding automobiles and boats registered to this person, insurance policies tied to the person (either in their own name or when listed as co-signers), criminal conviction history for the person, rental history for the person, property information associated with the individual, the person's payment trends and payment history with utility companies, and/or information regarding pets owned by the individual. The system may include features for including the alternate data types as part of the credit report process as well as a rules system for suppressing or excluding alternate data types which are cannot be used for any report and/or which cannot be used without the requisite permissions.

### Credit Report Generation System

In one embodiment, the credit report generation system 130 may generally enable users, such as consumer 150 and subscriber 152, to define custom microfinance credit reports that utilize the microfinance credit data. Based on product specifications for a given consumer or commercial product, and considering rules maintained by the credit report/score generation system, the credit report/score generation system may generate a credit report and deliver the generated report to the consumer. In some embodiments, the credit report/score generation system may enable concurrent access by a large number of clients and may be linearly scalable based on business needs of a given credit bureau or other operator.

The credit report generation system 130 may allow the user to customize a variety of display and reporting options, such as customizing payment grids for a variety of payment intervals, assigning a default payment grid, selecting more than one payment grid, and/or other options further described below. This flexibility allows lenders to display the credit reports related to microfinance credit accounts easily and make lending decisions accordingly. It also allows borrowers, which may include small business owners, to build up a credit history based on non-traditional loans and reporting cycles. The credit report generation system 130 may also store more than one set of rules for determining delinquency status associated with a microfinance credit account during a certain period of time. For example, depending on how frequently microfinance data is reported, delinquency status may be determined differently when a different payment interval is selected.

As illustrated in FIG. 1, the credit report/score generation system 130 includes a rules module 132, which includes data rules module 132A and display rules module 132B. The rules module 132 may retrieve and apply rules data stored in rules data store 140 when generating a microfinance credit report, determining delinquency status, and/or when responding to inquiries from users. Data rules may generally define which data types, data fields, and/or groups of data (also referred to as data bands) are available to potentially be accessed or included in a microfinance credit report, as well as what data types, data fields, and/or data bands are required.

In some embodiments, the data rules may also be customizable by an operator of the credit report generation system and/or by a user requesting a credit report (such as an operator of a financial institution, for example) to define how delinquency counters for microfinance credit data are calculated, which payment grids are pre-calculated for an account, and/or which payment grid is set as a default payment grid for an account. Delinquency counters may generally indicate how many times an account has been reported as delinquent in a given period. The data rules may also be customized, in some embodiments, to allow a bureau operator or other entity to set up rules for defining what level of details to include in a microfinance credit report as well as the layout and structure of a microfinance credit report.

The display rules may generally define which of those potentially available data types, data fields, and/or data bands are accessible for display with respect to a specific account, and which payment grids are to be displayed for a specific account. The display rules may be set at the time of an inquiry by a credit bureau operator or other entity, may be set in advance across an account (such as for all of a bank's users), may be set in advance for a particular subscriber or a group of subscribers (such as a bank subscriber to the microfinance credit reporting service that falls into a specific customer subset). As one example, a bank's vice presidents may have access to more data types, data fields, and/or data bands than the bank's mortgage account representatives. Data rules and/or display rules stored in rules data store 140 may include underlying regulatory or compliance rules (such as legal requirement regarding data fields that must be included when providing credit data in a given region), account-level rules, and/or user-level rules.

As an example, according to one embodiment, the rules module 132 may provide access to different data types. A credit bureau operator or other user may define a format for a given credit report by selecting at least a subset of the optional available data rules and display rules. A credit bureau operator or other user may also define one or more payment grids to be displayed on the credit report, which may or may not include the traditional monthly payment grid. A credit bureau operator or other user may also define the length of a particular payment interval using the user interface provided. The user interface module 134 may communicate with the rules module 132 in order to determine the available data and/or required data for a specific region, account, or type of users. The user interface module 134 may additionally communicate with the report module 136 in order to determine available report options such as payment grids, delivery considerations, and so forth. The report data storage 142 may store microfinance credit report specification information, including account-specific products, predefined microfinance credit report templates, one or more previously defined report formats, campaign templates, common credit inquiries, and so forth.

### Example Data Flow

As noted above, FIG. 1 illustrates one embodiment of an overall data flow of illustrative operating environment 100. The illustrative data flow begins with each of data suppliers 102, 104 and 106 sending microfinance credit data to the information management system 110. The microfinance credit data from each data supplier may be received at different times, or may be received simultaneously. As discussed above, the microfinance credit data may include a large variety of formats and types. For example, the microfinance credit data received from data supplier 102 may include payment status information on a weekly basis (for example, whether each account is current or past-due at the end of each week), while the microfinance credit data received from data supplier 104 may include payment status information based on 10-day payment periods. The information management system 110 may be capable of processing and reformatting the variety of formats and types.

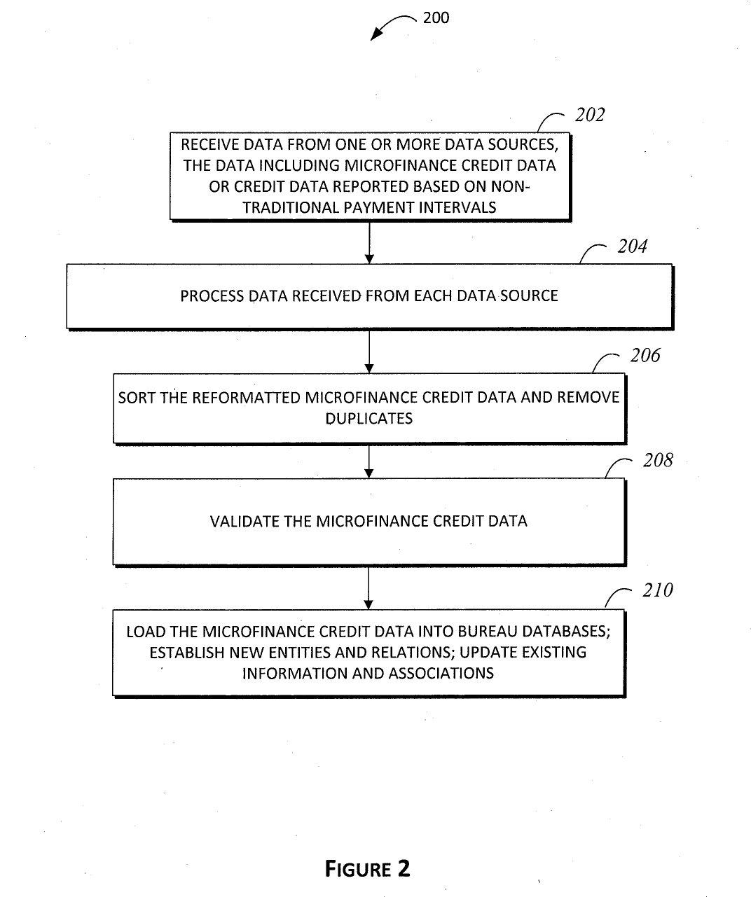

In the illustrative data flow, the information management system 110 pre-processes the microfinance data sets received from the various data suppliers in parallel. Pre-processing and processing the data, including generating alerts and tracking metrics, are described in more detail above, as well as with reference to FIG. 2 below. Metrics related to data loading and/or processing as well as data quality may be stored in the database 118 and/or in a separate metrics database. The information management system 110 may include a data preparation module 112, which may reformat, de-duplicate, and parse the received microfinance credit data. The information management system 110 may also include a data load module 114, which may further process the microfinance credit data, match data to data fields, and load the data into databases. The information management system 110 may also include a data retrieval module 116, which may be used to query an existing database 118 and store microfinance credit data. The data retrieval module 116 may also be used to retrieve credit data based at least in part on user and/or system-generated queries. In other embodiments, the querying, storing, and/or retrieval may be handled by the data load module 114.

In the illustrated embodiment, once the credit report/score generation system 130 receives the microfinance credit data, the credit report/score generation system 130 generates the microfinance credit report according to the relevant data rules 132A, display rules 132B and other relevant reporting format information. A variety of rules may be set up to allow flexibility in microfinance credit reporting. For example, for each microfinance credit account, rules may be determined and stored regarding how delinquency is determined, the default and/or available payment intervals, a default payment grid for reporting, and/or other rules. The generated credit report may then be provided to the relevant client(s), such as consumer 150, subscriber 152 and/or data supplier 106. Illustrative methods for data processing and user interfaces for displaying and customizing credit reports are discussed in more detail below.

### Example Methods Related to Incoming Data Files

FIG. 2 is a flow chart illustrating one embodiment of a method 200 implemented by the information management system 110 for receiving and processing credit data and/or other data received from a variety of data sources. The method 200 begins at block 202, where the information management system 110 receives data from one or more data sources or data suppliers. As discussed above, the received microfinance credit data may include consumer data, business data, account history, financial statements, public records, insurance information, vehicle records, rental information, property information, microfinance data, and/or other types of data. The received data may include, for example, data submitted to the information management system 110 by financial entities or other account providers to be included in credit files for a number of consumers and/or businesses for which the data supplier maintains accounts. In some embodiments, the data may include data that the information management system 110 specifically requests from one or more data sources, such as a public records data source. The data may also include non-credit data that can be directly or indirectly linked or tied to a consumer and/or business.

For example, microfinance credit data may include payment methods that include payment in non-monetary forms. It may also include payment made by non-monetary items first and then substituted with monetary payments within a period of time. For example, a small business that makes hand-woven baskets is funded by a line of microfinance credit. Payments are usually made weekly. However, during a week of low sale, some baskets are used as a method of payment, and when sales pick up and money is available, the baskets may be returned to the small business in return for a regular payment. Metadata may be stored in association with microfinance credit data that includes a particular purpose for the microfinance transaction (such as helping the elderly or disabled) and grace periods for payments that are longer than usual for a particular account or a group of accounts. In some embodiments, the credit report generation system may consider at least a portion of the stored metadata when generating credit reports. In some embodiments, the received data may be represented in a known file format, such as CCA, BCA, or others. In other cases, the received data may be represented in a file format not commonly used for credit reporting, such as plain text, user-defined file formats, and so forth.

The method 200 proceeds to block 204, where the information management system 110 processes data received from each data source or supplier. In some embodiments, the information management system 110 may first store the data in a local cache. In some other embodiments, the information management system 110 may store the data directly in a database, such as database 118.

Data processing performed at block 204 may include processing the data to locate information identifying an individual, business or other entity. The data processing may include calculating actual payment periods for the individual, business, or other entities associated with the received data. The data processing may include selecting, for reporting and analysis, a payment interval that is suitable for the account based on actual payment periods in the received data. For example, according to one embodiment, if the data received from a microfinance lending institution indicates that, for a given borrower, the actual payment period is about every 2 to 3 days most of the time, then a payment interval that may be selected as a default payment interval for that account could be every 3 days. In another example, according to one embodiment, if the actual payment period determined from the received credit data is calculated to be anywhere from 4 days to 2 weeks, then the information management system 110 may select a default payment interval for that account of 7 days.

The data processing may also include identifying the relevant data as microfinance credit data based at least in part on the data source, data type, payment intervals, metadata, and/or other received information. For example, the received credit data may be determined to be microfinance credit data based at least in part on a determination that the data includes non-traditional credit data files, user-defined credit data fields or data types, actual payment periods that are not 30-day or monthly, metadata identifying the account as a microfinance credit account, and/or other indicators. The data may be found by parsing the received credit data or by analyzing the metadata associated with the received data or data files. In some cases, certain lenders, such as some organizations that work with low-income customers in specific regions, may be flagged as a potential microfinance credit data provider, and data provided from such a supplier may be presumed to be microfinance related.

The data processing performed at block 204 may include reformatting the data, such as converting the received microfinance credit data from a variety of data formats into a single universal or proprietary format. The data processing may be implemented based at least in part upon information regarding frequently used formats and processing routines stored in the information management system 110. For example, if the information management system 110 usually processes data received from a data supplier in a certain way or using a certain routine, then data received from that supplier may be processed using that routine first. However, in case of new or unknown formats, and/or data received from new suppliers, the information management system 110 may parse and/or transform the data based at least in part on an analysis of identified data fields and/or data structures within the received microfinance credit data file. Such data transformation may be performed, for example, because the microfinance data received from certain data suppliers, especially small lenders, may be in non-traditional formats.

For example, according to one embodiment, if a file format is unknown to the information management system 110, the system may implement machine-learning or artificial intelligence-based data processing to perform data analysis, classify and/or match the data into data fields. After the pre-processing is done, the information management system 110 may store the location of the data fields, and then prepare the data for further processing. The information management system 110 may also use information associated with recognized data fields to convert the received data from the unknown format to one or more known formats.

In another use case, low-quality data may be received from a data supplier. The quality may be low because certain fields are missing from the data, and/or certain periods of time are missing from the data. If that is the case, the information-management system 110 may attempt to locate the missing data and/or determine default value for missing data. For example, if a data supplier does not report the address of a borrower, then the system may search other databases to find the borrower's address using the borrower's name, social-security number, and/or other identifying information. In another example, if a data supplier only supplies microfinance credit data when there are problems such as delinquencies, the system may assume that the unreported periods are non-delinquent periods and mark them as non-delinquent.

Microfinance credit data may also contain metadata that is useful for credit reporting, but does not fit easily into one of the existing credit reporting or data storage categories. In such cases, the information management system 110 may perform additional analysis of the metadata and/or optional data fields to store the metadata itself and/or additional information determined based at least in part on the metadata. For example, the metadata may indicate that a certain microfinance credit account is associated with a lender that works with the United Nation's effort in a certain region to provide work skills to under-privileged women. Due to the special nature of such an account, the metadata may indicate that non-payment or late-payment for up to 6 months should not be recorded as delinquent. The metadata may also indicate that the only payback expected for the first 2 years is a minimum amount that is smaller than industry customs.

In another example, the metadata may also indicate that payment may be made sometimes with non-monetary items. For example, a microfinance account's metadata indicate that payment by products such as hand-woven baskets are accepted. Accordingly, the payment data field and other related data fields in the information management system 110 and related databases can be updated to include non-monetary payment information.

In some cases, at least a subset of the received microfinance credit data may be very similar to traditional credit account data. For example, certain microfinance entities may have monthly payment cycles and other payment terms that are similar to those of traditional providers. In such cases, at least some of the received microfinance data may be mapped and reformatted to existing CCA or BCA universal formats. In other situations, the received microfinance credit data may not readily conform to a generally accepted data format. In some embodiments, the information management system 110 may process and store non-traditional data in an input format that mirrors the format in which the data was received from a data supplier. In other embodiments, the information management system 110 may process and store non-traditional data in a format specific to the information management system 110 that is designed to accommodate a wide variety of payment terms and/or other inconsistencies that may occur across different data suppliers' data formats.

At block 206, the information management system 110 sorts the data processed at block 204 and removes duplicates. Microfinance credit data from certain data suppliers may be more prone to having duplicates than traditional credit data because many microfinance data suppliers do not have the kind of data quality control or systematic data recording systems available to large lenders. In some embodiments, the information management system 110 may sort the data so that chronologically it is clear if there are periods of time missing from the supplied data. The information management system 110 may also sort the data so that it may detect that for a certain account in a certain period of time, duplicate credit data entries are included in the received data. In another example, the received credit data may be sorted by identifying information regarding an account, and duplicate entries may be removed as appropriate or flagged as data not to be saved.

In some embodiments, duplicate entries may not be exact duplicates, but rather have similar but non-identical information. The information management system 110 may process the data initially to find similar data entries. Then it may submit such entries for further analysis, such as machine-learning, data mining, or artificial intelligence based methods, to identify whether such entries containing non-identical but similar information should nonetheless be processed the same as duplicate entries. For example, various microfinance organizations' reported credit data might contain mistakes, typos, or inconsistent identifying information about borrowers and/or borrowing entities. As one example, in one reporting period, a microfinance organization may identify a borrower as Mr. John Smith living at North Pine Street, Los Angeles. During another reporting period, the organization may identify the same borrower as Dr. John Smith Jr. living at N. Pine St. #343, Rowland Heights. The information management system 110 may perform analysis based on name, address, birth date, social security number, and/or other information to identify the two entries as being associated with the same borrower.

In some embodiments, the data preparation module 112 may reformat, de-duplicate, and parse the data. In some other embodiments, the data load module 114 may perform matching and/or further data analysis to reformat, de-duplicate, and/or parse the data. Removing duplicates may, in some embodiments, also include the data load module 114 determining whether any duplicate records already exist in the database by querying an existing database 118. For example, after querying an existing database, it may be found that a microfinance lending agency has already submitted the same credit data previously.

For microfinance credit data, sorting may alternatively or additionally include sorting the received microfinance data using actual payment periods, payment date, name of an individual, business, or other entity. For example, records may be sorted based on all the accounts related to a particular business entity or charitable project. In another example, data may be sorted using birth dates, social security number, or other identifying information related to the accounts. The sorting may include, in some embodiments, reordering the microfinance data by the length of actual payment periods once actual payment periods are determined by the information management system. In some embodiments, after sorting and de-duplication, only one record may be retained when two or more exact duplicate data records are identified. In other cases, similar or duplicate entries may still be stored, but not used for credit reporting purposes. In some other cases, duplicate microfinance data entries with slightly different information and/or different metadata may be stored in the system, but only one entry used in credit reporting. In other embodiments, metadata and other unique aspects of the duplicate entries may be sent to the credit reporting generation system 130 and included in a credit report.

At block 208, the information management system validates the received microfinance credit data. In some embodiments, data validation may include the data load module 114 extracting relevant data fields from the received data. The data load module 114 may then query an existing database 118 using the data load module 114 to see if the records parsed from the received data match the data already stored. If there are conflicts, the data validation module may check more data fields to determine if there is a match or if there are problems with data quality. For example, the data load module 114 may check a microfinance account's past history to see whether the amount paid reported is roughly consistent with previous payment periods. For example, if it was previously reported that an account had a remaining balance of $800, and in an actual payment period, a payment of $5,000 is made, then there may be some problem with the microfinance data received. In such a case the data is flagged for further processing. In another example, if a business borrowing entity was previously recorded in the system as being in the industry of online advertising and located in a local business incubator, then an address of the borrowing entity showing that its location is in a high-end business complex may be a data quality control signal. There might be an address or entity mismatch in this case. In some embodiments, data quality issues may be resolved by undergoing more data mining and correction steps. In some other embodiments, problems may be reported by the information management system 110 to the data supplier for correction or further inquiries.

At block 210, the information management system loads the microfinance credit data into the databases 118, establishes new entities and relations, and/or updates existing information and associations. For example, if a data supplier provides microfinance data related to the purpose of the microfinance lending and the special payment terms related to certain accounts, the database may be updated to add data fields and/or metadata related to the special payment terms (such as payment types, non-monetary payment options, and so forth). In some embodiments, the information management system 110 may verify the input credit data against the relevant information already present in the database to determine whether new entities and relations need to be stored. The information management system 110 may insert new records of microfinance data into the database or updating existing records based on the new data. In some embodiments, details or updates regarding existing information and associations may be identified from the new data and stored in association with existing records. For example, if a microfinance credit account has previously only accepted monetary payments but recently began to accept non-monetary payments, the data type of the payments may need to be updated so that both monetary and non-monetary payments may be stored. If non-monetary payments are used, in some embodiments, the information management system 110 may also generate a rough estimate of the total cash value of the non-monetary payments made for the purposes of calculating delinquencies.

### Example Methods for Generating Data Reports for Microfinance Credit Data

In some embodiments, the credit report/score generation system 130 may enable a user, such as an operator, customer or partner of a credit bureau, to define custom credit reports that include microfinance credit data. Based on the specifications from a given user (such as a consumer, a microfinance creditor, or an entity interested in reviewing a credit report of an individual that includes information regarding microfinance account), and considering rules maintained by the credit report generation system's rules module 132, the credit report generation system 130 may generate a microfinance credit report and deliver the generated microfinance credit report to the user. The credit report/score generation system 130 may also generate a credit score and deliver the generated credit score to the user.

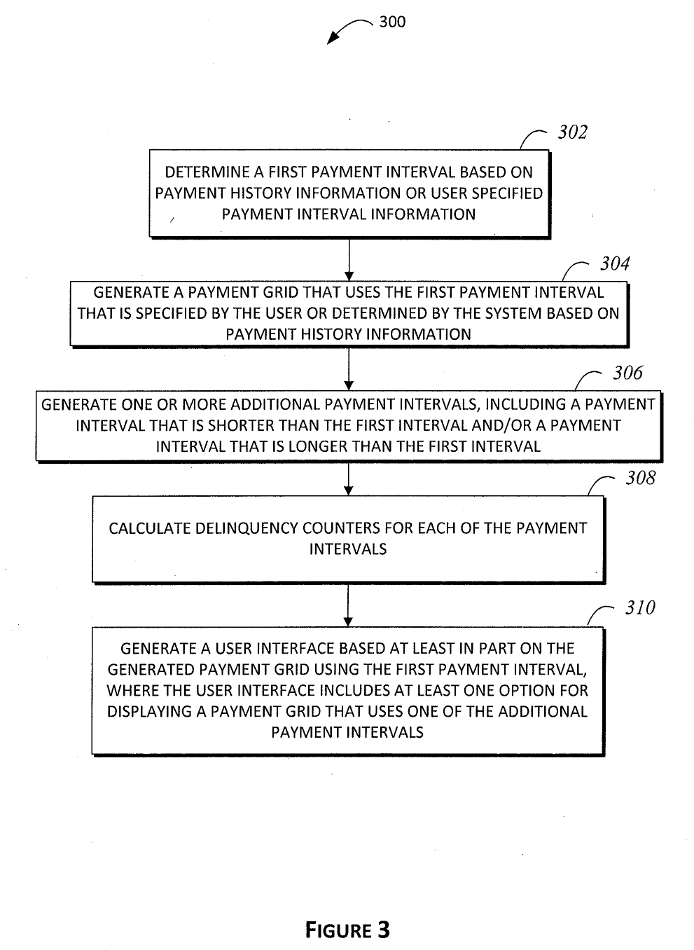

FIG. 3 is a flow chart illustrating one embodiment of a method implemented by the credit report generation system 130 for generating a customizable user interface that includes delinquency information associated with microfinance data. The method 300 begins at block 302, where the credit report/score generation system 130 determines a first payment interval. A first payment interval may be a time period such as one or more days, weeks, or months. It may be used to generate payment grids that are used in credit reports. For example, a payment interval of 5 days may be used to generate payment grids with entries in 5-day increments. An actual payment period may be different from a payment interval. In some embodiments, the credit report/score generation system 130 determines a first payment interval by reviewing payment history information and calculating the payment interval using the data rules module 132A. For example, if the actual payment period calculated from payment history information is around 6 to 8 days, then a first payment interval may be selected as 7 days. Using that 7-day payment interval, a 7-day payment grid may be generated. In some embodiments, the credit report generation system 130 receives the first payment interval from input provided by a credit bureau operator or an operator from another credit reviewing or reporting entity. For example, the operator may set the first payment interval as any number of days, weeks or month, or may be presented with certain predetermined intervals from which to select.

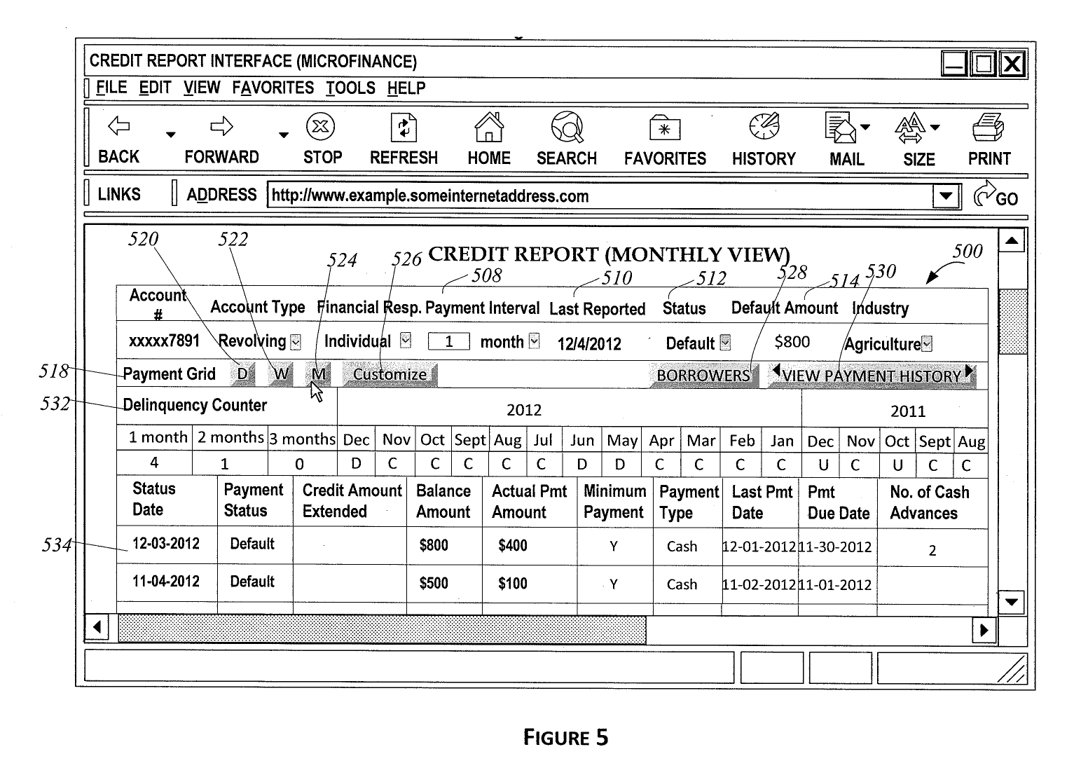

At block 304, the credit report generation system 130 generates a payment grid using the first payment interval. In some embodiments, a payment grid using the first payment interval may be pre-generated and stored by the credit report generation system 130. In other embodiments, a payment grid using the first payment interval may be generated dynamically as a request for the payment grid is received. FIGS. 5, 6, and 7, discussed below, provide examples of user interfaces with different payment grids. Generating a payment grid may include retrieving microfinance credit information and determining the payment status for each entry in the payment grid. Grace periods for payments, if available, may be included in the process of generating payment status. In some embodiments, the first payment interval may be the same or very similar to the actual payment periods provided in the microfinance payment data. For example, the actual payment periods provided in the microfinance data from a data supplier may indicate that the actual payment periods are usually every 14 days. Therefore, the credit report generate system 130, and in some embodiments, the data rules module 132A, may determine, based on the actual payment periods, that the first payment interval may be every 14 days. A payment grid may be generated using the 14-day first payment interval. In such a case, the credit report generation system 130 may use the processed microfinance credit data in database 118 to generate a payment grid. In this example, because the actual payment periods may match or be very similar to the first payment interval, the credit report generation system may use some data rules to calculate payment status and delinquency counters. In some embodiments, the data rules may specify that if a payment is late by one or more days, weeks, or months, the payment status may be set to “default.” For example, in some cases, if a payment is late by even one day, the credit report generation system 130 may set the payment status to “default.” In some other cases, if a payment is late or not made by more than half the duration of the first payment interval, the system 130 may set the payment status for a particular period to “default.” In some cases, if a payment is late or not made by more than ¼ of the duration of the first payment interval, the credit report generation system 130 may set the payment status for a particular period to “default.” In some cases, the credit report generation system 130 may use a period of time specified by an operator of a credit bureau or another entity that is engaged in microfinance credit reporting and reviewing to determine payment status.

In some embodiments, the first payment interval may be shorter than the actual payment periods provided in the received microfinance credit data. For example, the first payment interval may be 3 days, while the actual payment periods provided in the received microfinance credit data may be every 7 days. In some such cases, the received microfinance credit data may not provide payment status information at the more granular level of the shorter first payment interval. According to certain embodiments, the credit report generation system 130 may generate a payment grid using the first payment interval that is shorter than the actual payment periods. In some embodiments, the credit report generation system 130 may use the payment status generated for the actual payment period for a period of time in a payment grid.

In the example given above, the actual payment period may be 7 days, and the first payment interval may be 3 days. For a particular period of time between Dec. 3, 2012 and Dec. 5, 2012 in the payment grid, the credit report generation system 130 may use the payment status information determined for the actual payment period (which may be, for example, Dec. 1, 2012 to Dec. 7, 2012) as the payment status for this entry in the payment grid (Dec. 3, 2012 to Dec. 5, 2012). If a particular entry in the payment grid starts in one actual payment period and ends in the next actual payment period, in some embodiment, the credit report generation system may set the payment status as the actual period that includes more days in the particular payment grid entry. For example, the payment status in actual payment period 1 may be “default,” and the payment status in actual payment period 2 may be “current,” and the payment grid entry may include 2 days in the actual payment period 1 and 1 day in the actual payment period 2. In this case, the payment status may be set to “default.” If the payment grid entry includes equal numbers of days from actual payment period 1 and actual payment period 2, the credit report generation system may use the status of either actual payment period as the payment status. In other embodiments, any payment interval that includes at least one day of an actual payment period that was reported as a “default” status may also be displayed as a default status in the generated payment grid.

In some embodiments, the first payment interval may be longer than the actual payment periods provided in the received microfinance credit data. For example, the first payment interval may be 30 days. The actual payment periods received from the data supplier may be every 7 days. The credit report generation system 130 may first determine the payment status of each actual payment period within the given payment interval. In some embodiments, using the payment status information for each actual payment period within the first payment interval, the credit report generation system 130 may determine the payment status by finding the majority payment status. For example, if the payment status is default for 3 actual payment periods and current for 1 actual payment period within the payment grid entry, then based on the majority payment status rule, the payment status for this particular 30-day period may be set as “default.”

In some embodiments, the credit report generation system 130 may determine the payment status by using the payment status of the last actual payment period contained in the payment interval. For example, in the example given above, the actual payment periods may be every 7 days, and the first payment interval is 30 days. The credit report generation system 130 may determine that the payment status for the last actual payment period within this 30-day range is “current.” Therefore, the credit report generation system 130 may set the payment status of the entire period of time as “current.” In other embodiments, the credit report generation system 130 may consider the status as “default” for any payment interval that includes at least one actual payment period that was reported as being in default. In some embodiments, the credit report generation system 130 may also be configured to generate predicted future payment trends based at least in part on the payment status for one or more entries in the payment grid.

At block 306, the credit report/score generation system 130 generates one or more additional payment grids using payment intervals different from the first payment interval described above. In some embodiments, the payment grids are pre-generated and stored by the credit report generation system 130. In other embodiments, the payment grids may be generated dynamically as they are requested.

In some embodiments, the additional payment intervals may include one or more payment intervals that are shorter than the first payment interval and/or one or more payment intervals that are longer than the first payment interval. For example, if the first payment interval is 10 days, then the additional payment intervals may include a 7-day payment interval and a one-month payment interval. Therefore, additional payment grids may be generated to include a 7-day payment interval grid and a one-month payment interval grid. In some embodiments, the additional payment intervals may each be longer than the first payment interval or may each be shorter than the first payment interval.

Moreover, in some embodiments, the credit report generation system 130 may automatically select the one or more additional payment intervals in order to generate additional payment grids. The credit report generation system 130 may determine the lengths of the additional payment intervals based on a variety of factors, depending on the embodiment. For example, the credit report generation system 130 may calculate the actual payment periods based on received microfinance credit data. If the actual payment period is different than the first payment interval, then the actual payment period may be selected as an additional payment interval, and a payment grid using that additional payment interval may be generated. In some embodiments, the credit report generation system 130 may automatically select a payment interval that is approximately half the duration of the first payment interval and another payment interval that is approximately double the duration of the first payment interval, and generate the two additional payment grids using these additional payment intervals. In some embodiments, the credit report generation system 130 may randomly select a payment interval that is shorter than the first payment interval and another payment interval that is longer than the first payment interval from a predetermined list of acceptable payment intervals, and generate the resulting payment grids. In addition, in some embodiments, the credit report generation system 130 may use the payment intervals provided by an operator of a credit bureau, an authorized operator from a financial entity and/or input from a user requesting a credit report to generate additional payment grids.

At block 308, the credit report/score generation system 130 calculates the delinquency counters generated for a payment grid. For example, the data rules module 132A may receive a request to determine the delinquency status and/or delinquency counts, communicate with the rules data database 140 to retrieve a rule set for determining the delinquency status and/or counts, and calculate the number of delinquencies based on the rules. The credit report generation system 130 may include the delinquency counters within a generated payment grid on a customizable user interface generated by the credit report generation system, as further discussed below. Delinquency counters within a payment grid may also be generated using various rules, depending on the payment interval, the actual payment periods, and/or other information. For example, in some embodiments, delinquency counters may be generated based at least in part on the number of reported defaults in a particular period of time, which may be an integer with a minimal value of zero (indicating no reported defaults). In some embodiments, if data is not available for a given period of time, the delinquency counter may display “data not available” or a similar message.

In some embodiments, delinquency counters may calculate how many late or missed payments have incurred in a particular period of time. For example, if the actual payment period is 3 days, a 7-day delinquency counter may be generated based on how many 3-day payment periods included in the 7-day delinquency counter period are set to a status of “default.” In other embodiments, delinquency counters may be generated based on the last reported payment status in a particular period of time. For example, if the actual payment period is 3 days, a 7-day delinquency counter may be generated to reflect how many payments are made late or missed during that 7-day period. For example, a borrower may have made a late payment on Dec. 5, 2012, for the actual payment period of Dec. 1, 2012 to Dec. 3, 2012. He made an on-time payment on Dec. 6, 2012 for the actual payment period between Dec. 4, 2012 and Dec. 6, 2012. In this case, because by the end of the 7-day period, all the payments due are made, in some embodiments, the delinquency counter may be set to 0. However, if, for example, the system determines that even if a late payment is made, if it is made after some days/weeks/months, the late payment may still be recorded as one count of delinquency. In the example above, even though the payment was made on December 5, because it was late by 2 days (⅔ of the actual payment period), the system may determine, based on system-generated and/or operator-provided rules, that this late payment may be recorded as one count of delinquency.

In some embodiments, delinquency counters may be generated based on actual payment periods that are longer than the period of time included in the delinquency counters. For example, if the actual payment period is 30 days, and a delinquency counter may be generated based on 7-day period increments. In some embodiments, the credit report generation system 130 may determine whether in a 7-day period, there was any delinquency. In the example given above, the system 130 may determine that a payment deadline is on Dec. 1, 2012, and a payment for that actual payment period (30-day) is not made until Dec. 4, 2012. Therefore, the credit report generation system 130 may determine that there is one delinquency count during the 7-day delinquency counter period between Dec. 1, 2012 and Dec. 7, 2012. In another example, if a payment deadline is on Dec. 1, 2012, and a payment for that actual payment period (30-day) is not made until Dec. 15, 2012, then the credit report generation system 130 may determine that there is one count of delinquency for a 7-day delinquency counter between Dec. 1, 2012 and Dec. 7, 2012. The system 130 may likewise determine that there is one count of delinquency for a 14-day delinquency counter between Dec. 1, 2012 and Dec. 14, 2012. The system 130 may determine that if a 21-day delinquency counter is generated for the period of time between Dec. 1, 2012 and Dec. 21, 2012, then there is no delinquency because a payment is made on Dec. 15, 2012. However, in some embodiments, the system may determine that even if a payment is made, if it is made late by a given number of days/weeks/months, then it may still count toward one count of delinquency. In such a case, for example, the 21-day delinquency counter may be generated, and the system 130 may determine that because the payment is late by more than 5 days, for example, the 21-day delinquency count is also one. In some embodiments, when the credit report generation system 130 calculates payment status, it may also take into account the availability of payment grace periods. For example, if a payment was late by 30 days and a grace period of 15 days was available, then in some embodiments, the credit report generation system 130 may take the grace period into account and determine that the payment was only late by 15 days.

At block 310, the credit report/score generation system 130 generates a user interface based at least in part on the generated payment grid using the first payment interval. The payment grid may include information about payment status, status dates, balance amount, actual payment amount, minimum payment made, payment type, last payment date, payment due date, number of cash advances, and/or other information. The user interface may include at least one option for displaying a payment grid that uses one or more additional payment intervals. For example, a payment grid based on a 14-day payment interval may be presented with one or more selectable options for requesting an additional payment grid based on a 7-day payment interval and/or another payment grid based on a 30-day payment interval. As a result, the generated user interface may provide the user with multiple options for displaying payment grids and payment intervals.

### Example System Architecture

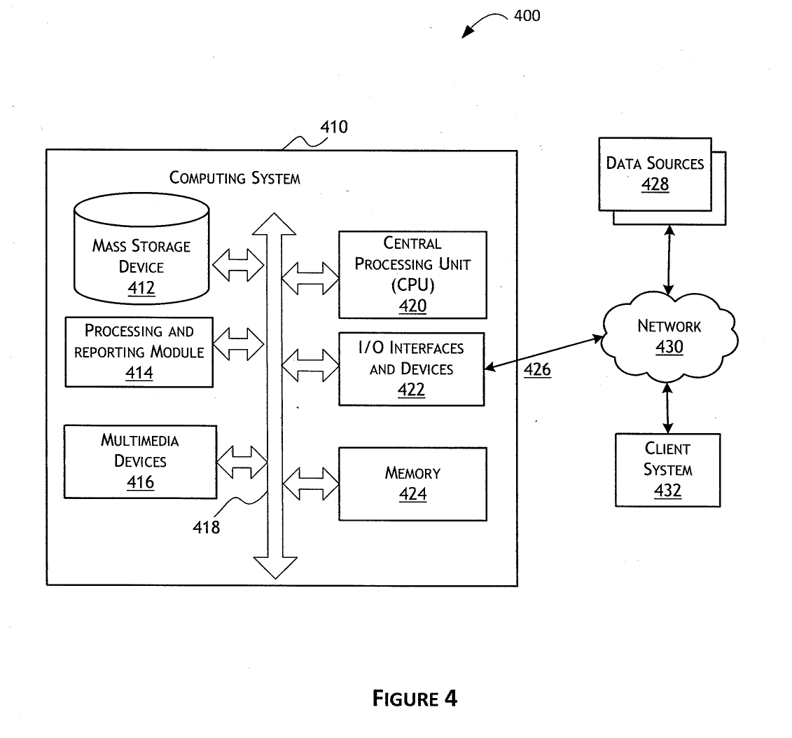

FIG. 4 is a block diagram showing an embodiment in which a computing system 410 is in communication with one or more data sources 428 and a client 432 via a network 430. The computing system 410 may be used to implement systems and methods described in this disclosure.

The computing system 410 includes, for example, a computer that may be IBM, Macintosh, or Linux/Unix compatible or a server or workstation. In one embodiment, the computing system 410 comprises a server, desktop computer or laptop computer, for example. In one embodiment, the exemplary computing system 410 includes one or more central processing units (“CPUs”) 420, which may each include a conventional or proprietary microprocessor. The computing system 410 further includes one or more memory 424, such as random access memory (“RAM”) for temporary storage of information, one or more read only memory (“ROM”) for permanent storage of information, and one or more mass storage device 412, such as a hard drive, diskette, solid state drive, or optical media storage device. Typically, the modules of the computing system 410 are connected to the computer using a standard based bus system 418. In different embodiments, the standard based bus system could be implemented in Peripheral Component Interconnect (“PCP”), Microchannel, Small Computer System Interface (“SCSI”), Industrial Standard Architecture (“ISA”) and Extended ISA (“EISA”) architectures, for example. In addition, the functionality provided for in the components and modules of computing system 410 may be combined into fewer components and modules or further separated into additional components and modules.

The computing system 410 is generally controlled and coordinated by operating system software, such as Windows XP, Windows Vista, Windows 7, Windows 8, Windows Server, Unix, Linux, SunOS, Solaris, or other compatible operating systems. In Macintosh systems, the operating system may be any available operating system, such as MAC OS X. In other embodiments, the computing system 410 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 410 may include one or more commonly available input/output (I/O) devices and interfaces 422, such as a keyboard, mouse, touchpad, and printer. In one embodiment, the I/O devices and interfaces 422 include one or more display devices, such as a monitor, that allows the visual presentation of data to a user. More particularly, a display device provides for the presentation of GUIs, application software data, and multimedia presentations, for example. The computing system 410 may also include one or more multimedia devices 416, such as speakers, video cards, graphics accelerators, and microphones, for example.

In the embodiment of FIG. 4, the I/O devices and interfaces 422 provide a communication interface to various external devices. In the embodiment of FIG. 4, the computing system 410 is electronically coupled to a network 430, which comprises one or more of a LAN, WAN, and/or the Internet, for example, via a wired, wireless, or combination of wired and wireless, communication link 426. The network 430 communicates with various computing devices and/or other electronic devices via wired or wireless communication links.

According to FIG. 4, information is provided to the computing system 410 over the network 430 from one or more data sources including, for example, data sources 428. The information supplied by the various data sources may include, for example, microfinance credit data, trade data, other credit data, personal data, public record data, social network data, and so forth. In addition to the devices that are illustrated in FIG. 4, the network 430 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, a record-based database, and/or an unstructured database.

A client system 432 may be connected to the network 430 and used by a user to send and receive information to and from the computing system 410. The client system 432 may be a desktop computer, a car computer, a mobile computer, or any other mobile device such as a mobile phone, smart phone, tablet or other similar handheld computing devices. The client system 432 and/or data sources 428 may include the same or similar components to those discussed above with reference to the computing system 410.

In the embodiment of FIG. 4, the computing system 410 also includes a processing and reporting module 414 that may be stored in the mass storage device 412 as executable software codes that are executed by the CPU 420. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 4, the computing system 410 is configured to execute the processing and reporting module 414 in order to implement functionality described elsewhere herein. For example, the processing module may perform methods described with reference to any of various modules described above with reference to the information management system 110 and/or the credit report generation system 130, depending on the embodiment.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 410, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, one or more computing systems, data stores and/or modules described herein may be implemented using one or more open source projects or other existing platforms. For example, one or more computing systems, data stores and/or modules described herein may be implemented in part by leveraging technology associated with one or more of the following: Drools, Hibernate, JBoss, Kettle, Spring Framework, NoSQL (such as the database software implemented by MongoDB) and/or DB2 database software.

### Example User Interface and Payment Grids

FIG. 5 is one embodiment of an illustrative user interface for configuring and displaying microfinance credit reports with various payment grid options. The user interface 500 may be generated by the credit report generation system 130 and presented for display on a user's computing device, such as consumer 150. The user interface 500 displays account information associated with a particular microfinance credit account. For example, the user interface displays account number 502, account type 504, and the party financially responsible for the account 506. As used in this section, the user to which the user interface is designed for may be an operator of a credit bureau, a person authorized to access and adjust credit review and reporting procedures in a financial entity, a subscriber of the microfinance credit reporting services, or a consumer, among others.

The user interface 500 also shows a payment interval 508. In this illustrative example, the payment interval being displayed is one month. The user interface 500 allows a user to set the duration of the payment interval and change the payment interval to other durations if the user so chooses. For example, the user may put in 10 days instead of a one-month payment interval. This gives the microfinance credit report users the flexibility to adjust the report to the level of detail that suits their particular needs.

The user interface 500 also displays the last reported date 510, which may be the date the credit bureau received the last reported payment on this account or the date that data was last received regarding the account. The user interface displays the status of the account 512, which may be “default,” “current,” or “unavailable,” according to the illustrated embodiment. In some embodiments, additional or different payment status indicators, such as numbers, symbols, or other messages may be used. The payment status for each entry in a payment grid may be determined by receiving a request to determine the payment status for each entry, retrieve a rule set for determining payment status, and calculating the payment status accordingly. The default amount 514 is also displayed in the user interface 500, which indicates that the accountholder is currently in default for $800. The user interface 500 also displays the industry this account is associated with, such as agriculture, education, services, and so forth.

The user interface 500 displays a payment grid 518 and several options 520, 522 and 524 for other payment grids. In this illustrative example, the payment interval used to generate the current payment grid in this example is a month. Several selectable options included in the user interface 500, including the daily payment grid option 520, the weekly payment grid option 522, the monthly payment grid option 524, and a customize payment grid option 526 are displayed next to the payment grid 518. In some embodiments, the default payment interval options displayed in a payment grid may be monthly or weekly. In some embodiments, default payment interval options may be updated or customizable.

In some embodiments, the credit report generation system 130 may pre-compute the information to be displayed for the payment grids using the data rules module 132A and the display rules module 132B and storing the pre-computed payment grids in the database. For example, the credit report generation system 130 may pre-compute the weekly and monthly payment grids displayed for a microfinance credit account. This may allow faster and more convenient display of frequently-used payment grids. Thereafter, if a user requests a pre-computed payment grid, the user interface module 134 may directly display the pre-computed payment grid. For example, when a user selects the monthly payment grid option 524, the system may present the user with a pre-computer monthly payment grid.

In some embodiment, the credit report generation system 130 may use the data rules module 132A and/or the display rules module 132B to generate the data to be displayed for each payment grid dynamically after receiving a user request. For example, when the user selects the weekly payment grid option 522, the credit report generation system 130 may dynamically generate the data to be displayed for a weekly payment grid, as discussed in more detail above with reference to FIG. 3.

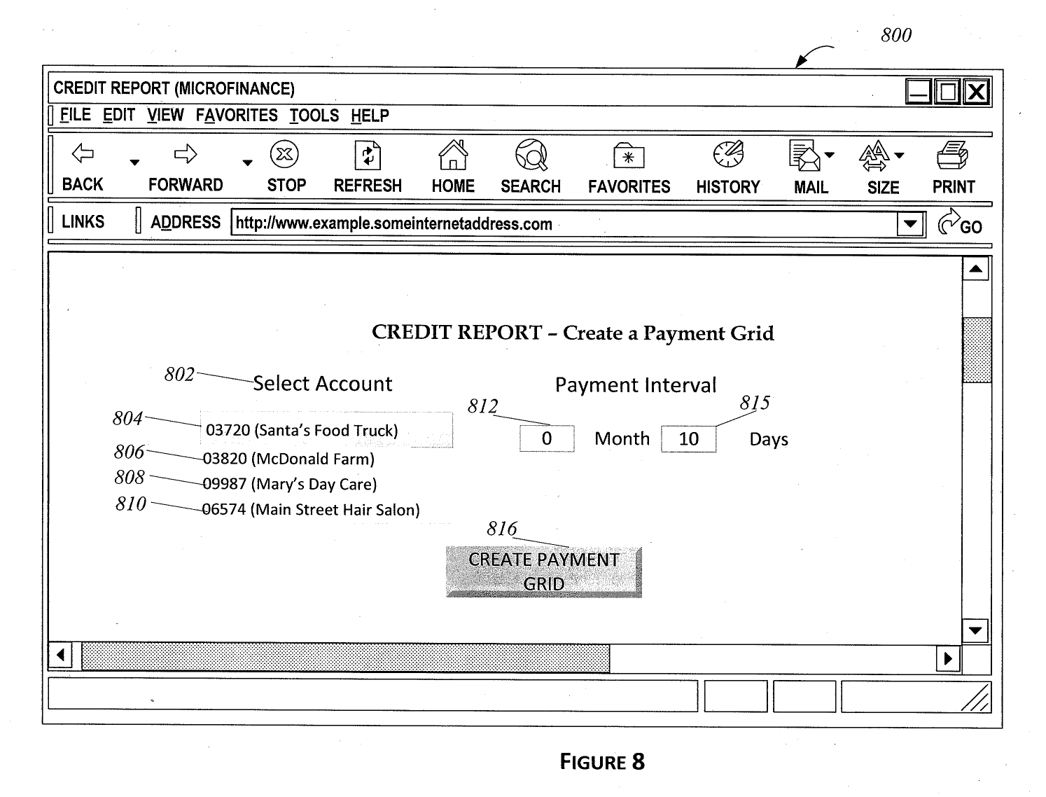

In some embodiments, the credit report generation system may pre-compute some payment grids but dynamically generate other payment grids. The system may choose to pre-compute the payment grids associated with the default payment interval associated with a microfinance credit account. In some embodiments, a user may set up the default payment interval associated with a microfinance credit account in the user interface. The user interface 500 also enables the user to customize the payment grid by selecting the customize option 526. Selection of option 526 may present the user with a user interface such as the illustrative example in FIG. 8, which is discussed further below.

The user interface 500 also allows the user to switch to other borrowers or accounts by selecting the borrowers option 528. The user interface allows the user to view payment history that is not the most recent period by selecting the view payment history option 530 and adjusting the reporting period to be displayed. For example, if the currently displayed payment period is Nov. 15, 2012 to Nov. 30, 2012, then by selecting the view payment history option 530, the payment information for Nov. 1, 2012 to Nov. 14, 2012, for example, may be displayed.

The user interface 500 also includes a delinquency counter 532, which may indicate how many times an account has been reported as delinquent in a given period of time or how many times a payment is late or missed during a given period of time. The credit report generation system 130 may also allow the user to define the data rules associated with how delinquencies are counted and reported in the user interface 500. For example, in some embodiments, the credit report generation system 130 may allow the user to define whether delinquency is calculated based on the total number of missed payments even if they are late by only one day or, instead, based on the last payment status in a given period of time. Other options may include, for example, specifying how many days a payment may be late and not count as a late payment for delinquency counter purposes. In some other embodiments, the option may include whether partial payments count toward late or missing payment for purposes of delinquency counters. The option may also include the percentage or minimum payment required for a partial payment to be not considered as delinquent. In other embodiments, non-monetary payment options may be set for delinquency counters. For example, if a borrower makes a payment using non-monetary items, the information management system 110 may allow a user to set the option of whether the monetary value of the items may be used for delinquency counter purposes. After the user customizes the rules associated with how delinquencies are reported, the credit report generation system 130 may display a new set of delinquency counter 532 for the user.

The user interface 500 may also include detailed payment history information 534, which may include the reported payment status date, payment status, credit amount extended, balance amount, actual payment amount, minimum payment amount, payment type, last payment date, payment due date, number of cash advances, and/or other information.

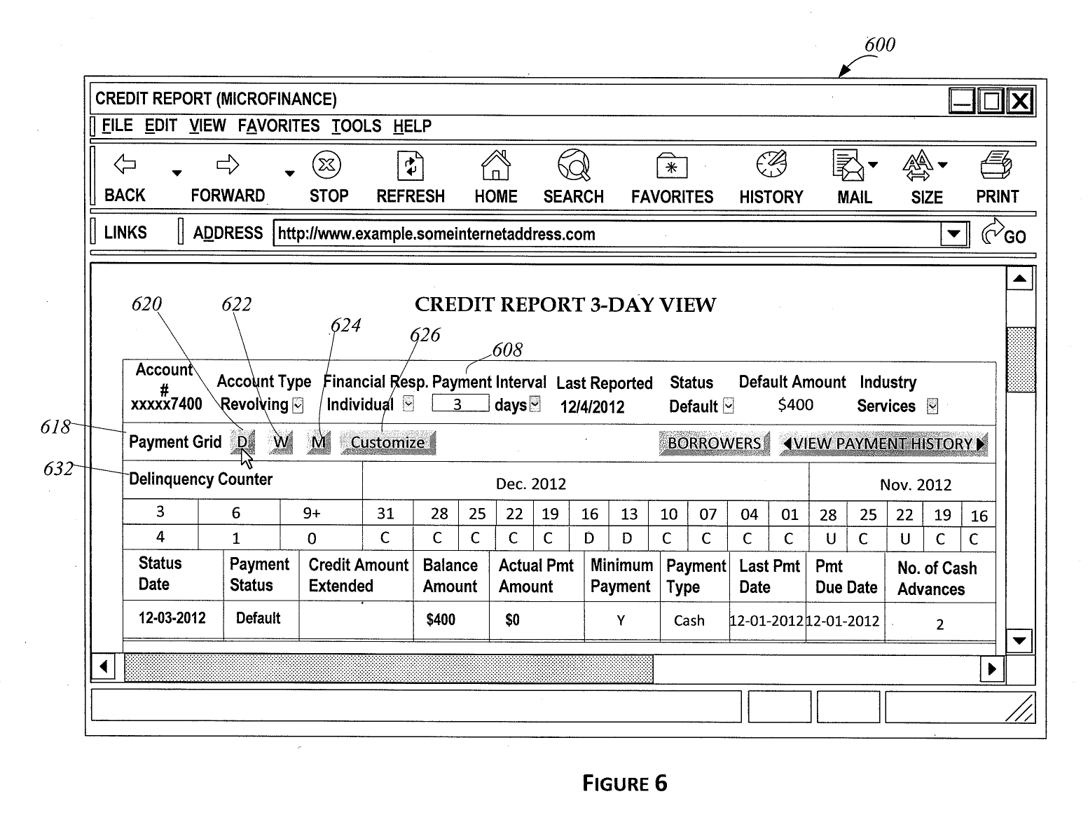

FIG. 6 is one embodiment of an illustrative user interface 600 for configuring and displaying microfinance credit reports with various payment grid display options. Similar to the user interface 500, user interface 600 allows the user to select and customize the payment grid. Unlike the user interface 500, the default payment interval displayed in user interface 600 is 3 days. This may be changed by the user in the payment interval field 608.

The user interface 600 may also give the user an option to switch to viewing other payment grids based on a different payment interval, such as a weekly (by selecting the weekly payment grid option 622) or a monthly payment grid (by selecting the monthly payment grid option 624). The user interface also includes a delinquency counter 632. The system may provide default additional payment grids based on a variety of factors, such as actual payment periods and the most frequently used payment grids associated with this or similar accounts. The system may allow the user to adjust the payment intervals associated with the additional payment grids.

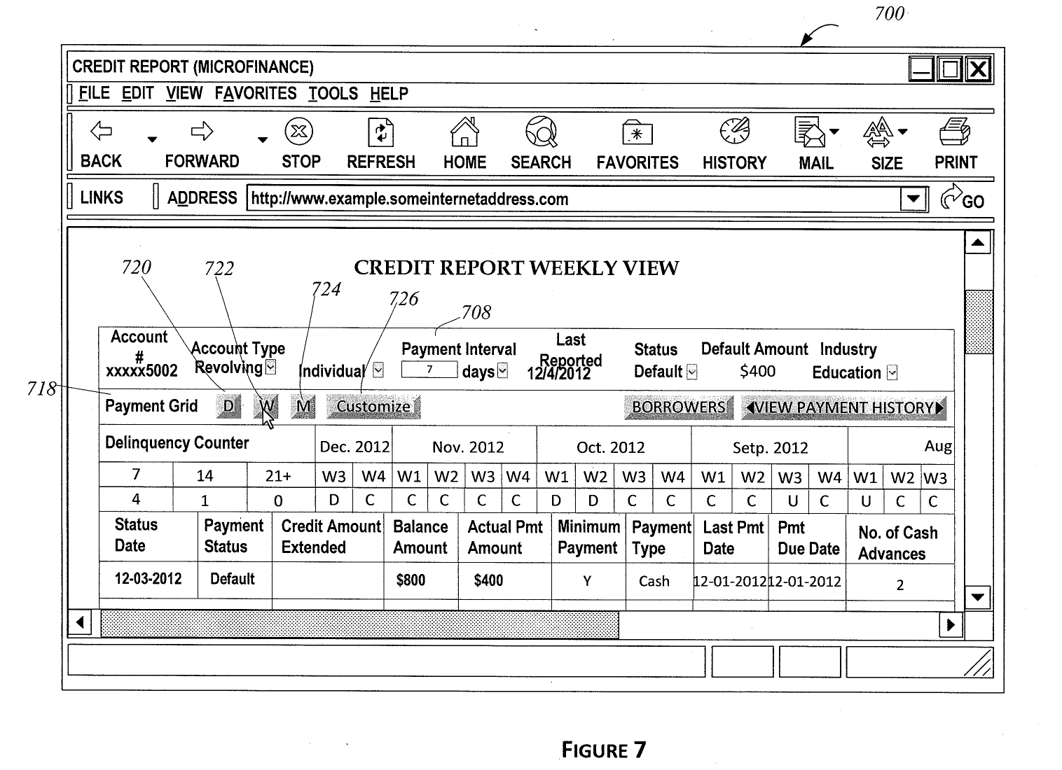

FIG. 7 is one embodiment of another illustrative user interface 700 for configuring and displaying microfinance credit reports with various payment grid display options. Similar to the user interfaces 500 and 600, user interface 700 allows the user to select and customize the payment grid by using options such as 720 (the daily payment grid option), 722 (the weekly payment grid option), 724 (the monthly payment grid option), 726 (the customize option), and 708 (the payment interval field). Unlike the user interfaces 500 and 600, however, the default payment interval displayed in user interface 700 is a week (indicated in payment interval field 708 as 7 days). This interval may be changed by the user in the payment interval field 708.

FIG. 8 is an illustrative example of a user interface 800 for creating a new payment grid. In some embodiments, such a user interface may be presented to a user such as an executive, administrator, or other person associated with a microfinance credit entity or credit bureau, to allow the user to customize a payment grid according to the specific needs of the microfinance credit entity and/or to configure display rules that will be used by the rules module 132 when generating products. The user interface 800 presents a choice of microfinance credit accounts 802, where the user may choose the account for which to create a new payment grid. In this illustrative example, the user is presented with four microfinance credit accounts 804-810 to choose from. The user interface 800 is also configured to allow the user to input the payment interval. In this example, the user has entered zero months in the month field 812 and 10 days in the day field 815. Therefore, the user-interface 800 allows the user to create a customized payment grid, which uses a 10-day payment interval. After the user selects the “create payment grid” option 816, the user may receive confirmation that a new payment grid with a payment interval of 10 days is created. Afterwards, the user may view a credit report based on the 10-day payment interval. Additionally or alternatively, the credit report generation system 130 may store a payment grid for the selected account to be used by the rules module 132 when generating reports for the selected account in the future.

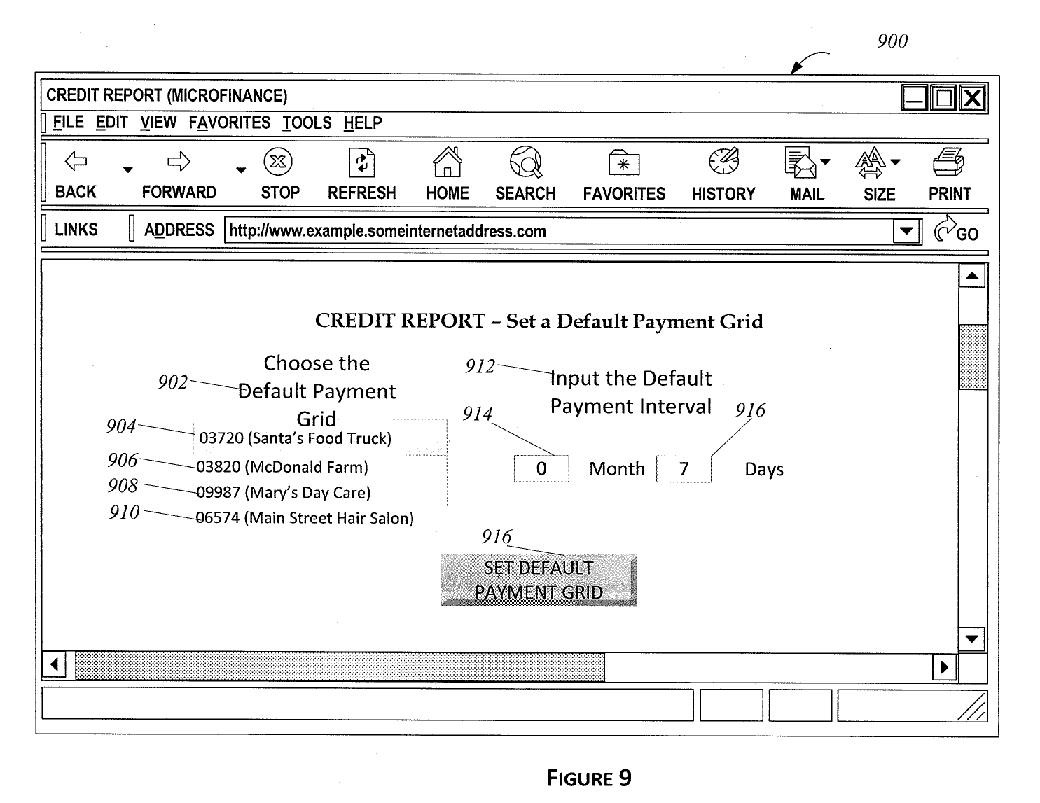

FIG. 9 is an illustrative example of a user interface 900 for selecting a default payment grid. In some embodiments, such a user interface may be presented to a user such as an executive, administrator, or other person associated with a microfinance credit entity or credit bureau, to allow the user to set a default payment grid according to the specific needs of the microfinance credit entity and/or to configure display rules that will be used by the rules module 132 when generating products. The credit report/score generation system may directly assign a default payment grid to a microfinance credit account based on past payment history information such as actual payment periods. However, if the user wishes to adjust the default payment grid, the user may customize the default settings using the user interface 900. The user interface 900 presents a choice of microfinance credit accounts 902-910 to the user. The user interface 900 is also configured to allow the user to set up a default payment interval. In this example, the user has entered zero months in the month field 914 and 7 days in the day field 916. Therefore, the user interface 900 allows a user to set a default payment grid with a 7-day payment interval for a particular microfinance credit account. The user may also select multiple accounts and set up the default payment grid for all or each of them.

### Other Embodiments

Although the foregoing systems and methods have been described in terms of certain embodiments, other embodiments will be apparent to those of ordinary skill in the art from the disclosure herein. Additionally, other combinations, omissions, substitutions and modifications will be apparent to the skilled artisan in view of the disclosure herein. While some embodiments of the inventions have been described, these embodiments have been presented by way of example only, and are not intended to limit the scope of the inventions. Indeed, the novel methods and systems described herein may be embodied in a variety of other forms without departing from the spirit thereof. Further, the disclosure herein of any particular feature, aspect, method, property, characteristic, quality, attribute, element, or the like in connection with an embodiment can be used in all other embodiments set forth herein.

All of the processes described herein may be embodied in, and fully automated via, software code modules executed by one or more general-purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

What is claimed is:

1. A credit reporting system comprising:
a database configured to store a plurality of records, wherein the plurality of records each comprises credit data associated with a plurality of accounts, wherein the database is configured to store credit data that includes payment status information for accounts associated with a plurality of payment intervals; and
a credit report generation system configured to electronically communicate with the database, the credit report generation system comprising:
a report module configured to:
receive a report request indication identifying a first individual for whom a credit report should be generated;
retrieve credit data associated with the individual from the database, wherein the retrieved credit data includes payment status information associated with a first financial account of the individual;
determine payment status for each entry in a first payment grid representing the retrieved credit data, the first payment grid comprising entries corresponding to a first payment interval, wherein the first payment interval comprises one of daily, weekly and monthly; and
determine payment status for each entry in a second payment grid representing the retrieved credit data, the second payment grid comprising entries corresponding to a second payment interval that is different than the first payment interval, wherein the second payment interval comprises one of daily, weekly and monthly; and
a user interface module configured to:
present a credit report including the first payment grid comprising entries corresponding to the first payment interval, wherein the credit report includes at least one selectable option enabling the user to view the second payment grid comprising entries corresponding to the second payment interval; and
in response to a user selection of the at least one selectable option, presenting the second payment grid comprising entries corresponding to the second payment interval.

2. The system of claim 1, wherein the credit report generation system is further configured to:
receive a request to generate a credit report based on a user-defined payment interval;
generate a payment grid having entries corresponding to the user-defined payment interval; and
determine payment status for each entry in the payment grid corresponding to the user-defined payment interval.

3. The system of claim 1, wherein the credit report generation system is further configured to:
receive a request to designate a payment grid as a default payment grid for a financial account; and
in response to a request for credit data associated with the financial account, generate the default payment grid for display.

4. The system of claim 1, wherein determining the payment status for each entry in the second payment grid comprises:
retrieving a rule set for determining payment status, wherein the rule set is associated with the second payment interval; and
determining the payment status for each entry in the second payment grid based at least in part on the rule set and payment status information associated with a payment interval other than the second payment interval.

5. The system of claim 1, wherein the credit report generation system is further configured to:
receive a user defined rule set for determining a payment status for each entry in a third payment grid; and
determine a payment status for each of a plurality of entries in the third payment grid based at least in part on the user defined rule set.

6. The system of claim 1, wherein the payment status for each entry in the second payment grid is determined based at least in part on one or more actual payment periods associated with the first financial account of the individual, wherein the one or more actual payment periods are different than the second payment interval.

7. The system of claim 6, wherein the one or more actual payment periods are shorter than the second payment interval.

8. A computer-implemented method for reporting credit data, the computer-implemented method comprising:
receiving a credit report request indication identifying a first individual for whom a credit report should be generated;
retrieving credit data associated with the individual from one or more data stores, wherein the retrieved credit data includes payment status information associated with each of a plurality of payment periods for a first financial account of the individual;
determining payment status for each entry in a first payment grid representing the retrieved credit data, the first payment grid having entries corresponding to a first payment interval, wherein the first payment interval comprises one of daily, weekly and monthly; and
determining payment status for each entry in a second payment grid representing the retrieved credit data, the second payment grid having entries corresponding to a second payment interval that is different than the first payment interval, wherein the second payment interval comprises one of daily, weekly and monthly, wherein the second payment interval is of a different length than an actual payment period associated with the first financial account of the individual.

9. The computer-implemented method of claim 8, wherein the method further comprises:
receiving a request to generate a credit report based on a user-defined payment interval;
generating a payment grid having entries corresponding to the user-defined payment interval; and
determining payment status for each entry in the payment grid corresponding to the user-defined payment interval.

10. The computer-implemented method of claim 8, wherein the method further comprises:
receiving a request to designate a payment grid as a default payment grid for a financial account; and
in response to a request for credit data associated with the financial account, generating the default payment grid for display.

11. The computer-implemented method of claim 8, wherein the method further comprises dynamically calculating a plurality of payment intervals associated with an account.

12. The computer-implemented method of claim 8, wherein method further comprises pre-calculating a plurality of payment intervals associated with an account.

13. The computer-implemented method of claim 8, wherein the payment status for each entry is selected from a group comprising at least current and default.

14. The computer-implemented method of claim 8, wherein determining the payment status for each entry in the second payment grid further comprises:
retrieving a rule set for determining payment status, wherein the rule set is associated with the second payment interval; and
determining the payment status for each entry in the second payment grid based at least in part on the rule set and payment status information associated with a payment interval other than the second payment interval.

15. The computer-implemented method of claim 8, wherein the method comprises:
receiving a user defined rule set for determining a payment status for each entry in a third payment grid; and
determining a payment status for each of a plurality of entries in the third payment grid based at least in part on the user defined rule set.

16. The computer-implemented method of claim 8, wherein method further comprises receiving a payment grace period, wherein the payment status for each entry in the second payment grid is determined based at least in part on the payment grace period.

17. The computer-implemented method of claim 8, wherein the method further comprises generating predicted future payment trends based at least in part on the payment status for one or more entries in the first payment grid.

18. The computer-implemented method of claim 8, wherein the method further comprises receiving and processing credit data that includes non-monetary payments.

19. The computer-implemented method of claim 8, wherein the method further comprises receiving and processing microfinance credit data.

20. The computer-implemented method of claim 8, wherein the payment status for each entry in the second payment grid is determined based at least in part on one or more actual payment periods associated with the first financial account of the individual, wherein the one or more actual payment periods are different than the second payment interval.

21. The computer-implemented method of claim 20, wherein the one or more actual payment periods are shorter than the second payment interval.

22. The computer-implemented method of claim 20, wherein the one or more actual payment periods are longer than the second payment interval.

23. A non-transitory computer-readable storage medium comprising computer-executable instructions that direct a computing system to:
receive a report request indication identifying a first individual for whom a credit report should be generated;
retrieve credit data associated with the individual from one or more data stores, wherein the retrieved credit data includes payment status information associated with a microfinance loan associated with the individual, wherein the microfinance loan is associated with one or more payment periods whereby multiple payments are due in each month;
determine payment status for each entry in a first payment grid representing the retrieved credit data, the first payment grid having entries corresponding to a first payment interval that is different than the one or more payment periods;
determine payment status for each entry in a second payment grid representing the retrieved credit data, the second payment grid having entries corresponding to a second payment interval that is different than the first payment interval and the one or more payment periods;
present a credit report including the first payment grid having entries corresponding to the first payment interval, wherein the credit report includes at least one selectable option configured to cause the presentation of the second payment grid having entries corresponding to the second payment interval; and
based at least in part on a user selection of the at least one selectable option, present the second payment grid having entries corresponding to the second payment interval.

24. The non-transitory computer-readable storage medium of claim 23, wherein the first payment interval is weekly and the second payment interval is monthly.

25. The non-transitory computer-readable storage medium of claim 23, wherein the executable instructions further direct the computing system to:
receive a request to generate a credit report based on a user-defined payment interval;
generate a payment grid having entries corresponding to the user-defined payment interval; and
determine payment status for each entry in the payment grid corresponding to the user-defined payment interval.

26. The non-transitory computer-readable storage medium of claim 23, wherein the executable instructions further direct the computing system to:
receive a request to designate a payment grid as a default payment grid for a financial account; and
in response to a request for credit data associated with the financial account, generate the default payment grid for display.

27. The non-transitory computer-readable storage medium of claim 23, wherein the executable instructions further direct the computing system to:
receive a user defined rule set for determining a payment status for each entry in a third payment grid; and
determine a payment status for each of a plurality of entries in the third payment grid based at least in part on the user defined rule set.

28. The non-transitory computer-readable storage medium of claim 23, wherein the payment status for each entry in the second payment grid is determined based at least in part on one or more actual payment periods associated with the first financial account of the individual, wherein the one or more actual payment periods are different than the second payment interval.

29. The non-transitory computer-readable storage medium of claim 28, wherein the one or more actual payment periods are shorter than the second payment interval.
